(19) United States
(12) Patent Application Publication
(10) Pub. No.: US 2016/0202891 A1
(43) Pub. Date: Jul. 14, 2016

(54) Instruments 3D Display System

(71) Applicant: JAGUAR LAND ROVER LIMITED, Coventry, Warwickshire (GB)

(72) Inventors: Elvir Hasedzic, Coventry, Warwickshire (GB); Lee Skrypchuk, Coventry, Warwickshire (GB)

(21) Appl. No.: 14/915,095

(22) PCT Filed: Sep. 2, 2014
(86) PCT No.: PCT/EP2014/068634

§ 371 Date: Feb. 26, 2016

(30) Foreign Application Priority Data
Sep. 3, 2013 (GB) 1315620.3

(51) Int. Cl. G06F 3/0484; H04N 13/04; B60R 1/00; G06F 3/0481

(52) U.S. Cl. CPC G06F 3/04847; G06F 3/04815; H04N 13/0409; B60R 1/00; B60R 2300/50; B60R 2300/20

(57) ABSTRACT

The present invention relates to an instrument display system. The display system includes an instrument display panel (2) and a programmable electronic control unit (3). The instrument display panel (2) is a 3-D instrument display panel configured to display infographics (4-13) associated with parameters of a motor vehicle. The electronic control unit (3) is programmed to position each of the infographics (4-13) at an apparent depth within the 3-D instrument display panel (2) dependent on their priority.

### TECHNICAL FIELD

The present disclosure relates to an instrument display panel for a motor vehicle, to an instrument display system incorporating such a panel, to a motor vehicle incorporating such a system, and to a method of displaying information on such an instrument display panel. Aspects of the invention relate to a panel, to a system, to a method and to a vehicle.

### BACKGROUND OF THE INVENTION

A conventional instrument panel is constituted by a plurality of gauges, such as a speedometer, a tachometer, a fuel gauge, a rev counter, an engine temperature gauge, one or more warning lights (such as a battery charge indicator, an ABS warning light, a tyre pressure warning light and an engine malfunction warning light).

Recently, there has been developed a fully digital instrument display panel that uses computer graphics to present all information, such as a speedometer, on a TFT LCD panel. Use of computer graphics helps realise a flexible instrument panel that displays information only when necessary or enables different colours to be used during daytime and night-time operation.

A problem identified with known instrument panels is prioritising the displayed information. This problem is particularly relevant when a large amount of information is displayed on the instrument panel, none of which is prioritised. Consequently, it is relatively common for a driver not to notice information which requires urgent attention, for example information relating to the over-heating of the engine, or dangerous proximity to a vehicle in front, or an obstruction behind. Conventional approaches to this problem include increasing the relative size of the displayed information or flashing the information. However, there are certain legislative requirements which limit the ability to prioritise information on a conventional display. For example, in many jurisdictions there legislation requires that certain data remains available at all times, for example icons cannot overlie the speedometer.

At least in certain embodiments, the present invention seeks to provide an instrument display panel that facilitates prioritisation of the information displayed.

### SUMMARY OF THE INVENTION

Aspects of the present invention relate to an instrument display panel for a motor vehicle, to an instrument display system incorporating such a panel, to a motor vehicle incorporating such a system, and to a method of displaying information on such an instrument display panel.

A further aspect of the invention relates to an instrument display system comprising an instrument display panel and a programmable electronic control unit, wherein the instrument display panel is a 3-D instrument display panel configured to display infographics associated with parameters of a motor vehicle, and the electronic control unit is programmed to position each of the infographics at an apparent depth within the 3-D instrument display panel dependent on their priority.

The apparent depth at which each of said infographics is positioned within the 3-D display can be reduced (i.e. the infographic appears closer to the front of the 3-D instrument display panel resulting in a decrease in the apparent distance between the infographic and a user positioned in front of the display panel) to represent a higher priority. The apparent depth at which each of said infographics is positioned within the 3-D display can be increased (i.e. the infographic appears closer to the back of the 3-D instrument display panel resulting in an increase in the apparent distance between the infographic and a user positioned in front of the display panel) to represent a lower priority. The electronic control unit can be dynamically configurable to display each infographic at a relative apparent depth within the 3-D display which is indicative of the relative priority of the operating parameters associated with that infographic. The electronic control unit can be programmed to position the infographics associated with parameters of higher priority towards the apparent front of the 3-D instrument display panel. Conversely, the electronic control unit can be programmed to position the infographics associated with operating parameters of lower priority towards the apparent rear of the 3-D instrument display panel.

The 3-D instrument display panel can define a plurality of virtual display planes positioned at different apparent depths within the display panel. The apparent distance from a user to the displayed infographics varies depending on the apparent depth at which the infographic is displayed in the 3-D display.

A first infographic can display a speedometer of the motor vehicle, and the electronic control unit can be programmed to position the first infographic in a first apparent display plane. The first apparent display plane can function as a reference plane within the 3-D display.

The electronic control unit can be programmed to position the speedometer infographic in the first apparent display plane, and higher priority infographics can be displayed in one or more apparent display planes disposed at a reduced apparent depth than the first apparent display plane. Conversely, the electronic control unit can be programmed to position the lower priority infographics for displayed in one or more apparent display planes disposed at an increased apparent depth than the first apparent display plane.

The electronic control unit can be programmed to position an infographic associated with a parameter of highest priority in a predetermined apparent display plane at an apparent frontmost position within the 3-D display. The infographic can be displayed in said frontmost position without obscuring the user's view of the speedometer infographic. The electronic control unit can be programmed to position an infographic associated with a parameter of lowest priority in a predetermined apparent display plane at an apparent rearmost position within the 3-D display.

The relative priority of the operating parameters can be predefined, for example the apparent plane defined for each infographic can be stored in a look-up table. The electronic control unit can be programmed to choose the infographic of highest priority in dependence upon information received by the electronic control unit as to which of any one of a plurality of critical parameters is faulty or does not comply with a predetermined value or range of values. The electronic control unit can be programmed to change the apparent plane in which an infographic is displayed (to increase or decrease the apparent depth) based on said information. The information can, for example, indicate that a priority indicator associated with a particular infographic has changed and the electronic control unit can be programmed to make a corresponding change to the apparent plane in which that infographic is displayed.

The infographic can be displayed in a single apparent display plane. Alternatively, the infographic for a particular parameter can be moved between apparent display planes, for example to represent changing status information. For example, the apparent display plane in which the infographic is displayed can be changed depending on operating data relating to the associated parameter. The electronic control unit can be configured to reduce the apparent depth of the plane in which the infographic is displayed when operating data determines that action is required. Conversely, the electronic control unit can be configured to increase the apparent depth of the plane in which the infographic is displayed when operating data determines that action is not required. The electronic control unit can be programmed so that the infographics of critical parameters are normally displayed in an apparent background plane (for example an apparent display plane further from the user than the first apparent display plane containing the speedometer infographic), but each can be moved to an apparent foreground plane (for example an apparent display plane closer to the user than the first apparent display plane containing the speedometer infographic) when the associated critical parameter is faulty or does not comply with a predetermined value or range of values.

The critical parameters can relate to one or more of the following: a tyre pressure warning, an ABS faulty warning, and an engine malfunction warning. The critical parameters can also include inter alia, a reversing warning indicator, a warning that the speed limit is being exceeded, and a warning that a seat belt is not being worn by an occupant of the motor vehicle.

At least in certain embodiments, the 3-D display can be an autostereoscopic parallax display which emits directionally-varying image information to present a 3-D image to the user. Alternatively, the 3-D display can be a holographic display or a 3-D head-up display (HUD). The higher priority infographics can be displayed at negative parallax positions and lower priority infographics can be displayed at positive parallax positions.

In a further aspect, the present invention relates to a motor vehicle incorporating an instrument display system as defined above.

The motor vehicle can further comprise means for sending warning information to the electronic control unit to identify which of a plurality of critical parameters is faulty or does not comply with a predetermined value or range of values. The sending means can be in the form of a transmitter, for example coupled to a notification centre.

In a further aspect of the present invention there is provided a 3-D instrument display panel for a motor vehicle, wherein the 3-D display is an autostereoscopic parallax display which emits directionally-varying image information to present a 3-D image to the user, with higher priority infographics being displayed at negative parallax positions and lower priority infographics being displayed at positive parallax positions.

In yet a further aspect of the present invention there is provided a method of displaying infographics associated with parameters of a motor vehicle, the method including the steps of sending information to an electronic control unit relating to parameters of the motor vehicle, programming the electronic unit to position infographics associated with the parameters on a 3-D instrument display panel so that infographics of higher priority are positioned so as to appear nearer to a user positioned in front of the panel.

The method can further comprise the step of programming the electronic unit to position an infographic in the highest priority position apparently nearest the user in dependence upon information received by the electronic control unit as to which one of a plurality of critical parameters is faulty or does not comply with a predetermined value or range of values, said infographic being associated with said one critical parameter

The term 3-D has been used herein as an abbreviation of the term three (3) dimensional. As determined by the context in which the term is used herein, this refers to the display of a graphical image (or images) in three dimensions or a display apparatus suitable for displaying graphical images in three dimensions.

Within the scope of this application it is expressly envisaged that the various aspects, embodiments, examples and alternatives set out in the preceding paragraphs, in the claims and/or in the following description and drawings, and in particular the individual features thereof, can be taken independently or in any combination. Features described in connection with one embodiment are applicable to all embodiments, unless such features are incompatible

### BRIEF DESCRIPTION OF THE DRAWINGS

An embodiment of the present invention will now be described, by way of example only, with reference to the accompanying drawings, in which:

FIG. 1 is a schematic view of a motor vehicle incorporating an instrument display panel; and

FIG. 2 is a schematic representation of the 3-D display of the panel of FIG. 1.

### DETAILED DESCRIPTION OF AN EMBODIMENT

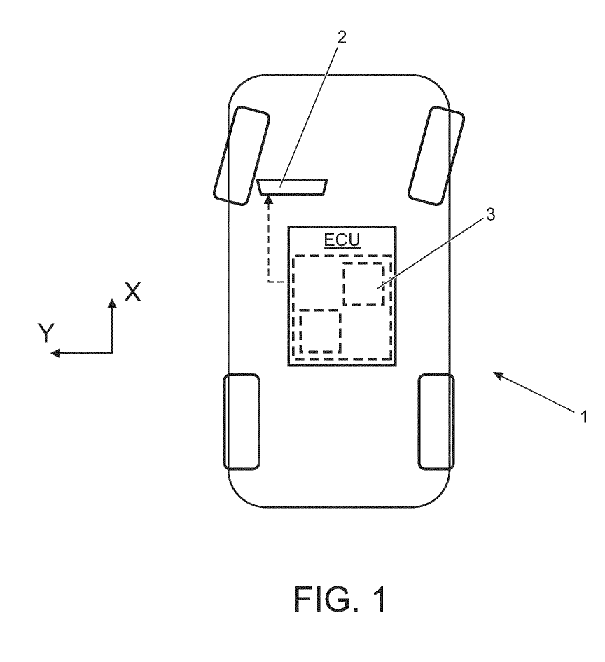

Referring to the drawings, FIG. 1 shows a motor vehicle 1 having an indicator display panel 2 and an electronic control unit (ECU) 3. The ECU 3 is software controlled to send infographics (graphic visual representations of information, data or knowledge intended to present complex information quickly and clearly) to the panel 2.

The ECU 3 can be part of the same assembly as the panel 2 or it can be located somewhere within the vehicle detached from the panel 2. The panel 2 is an autostereoscopic display panel which presents a three-dimensional image to a viewer without the need for glasses or other encumbering viewing aids. The autostereoscopic display is a parallax display which emits directionally-varying image information into the viewing zone. The 3-D autostereoscopic display technology typically generates a 2-D image to each eye, in order to provide the user with depth information of the infographics. In particular, the infographics in the parallax space can be used to prioritise the level of priority/urgency of warning or information to the user under software control by the ECU 3. Parallax is a displacement or difference in the apparent position of an object viewed along two different lines of sight, and is measured by the angle or semi-angle of inclination between those two lines. Thus, with positive parallax: objects appear behind the screen (increased apparent depth); and with negative parallax: objects appear in front of the screen (reduced apparent depth).

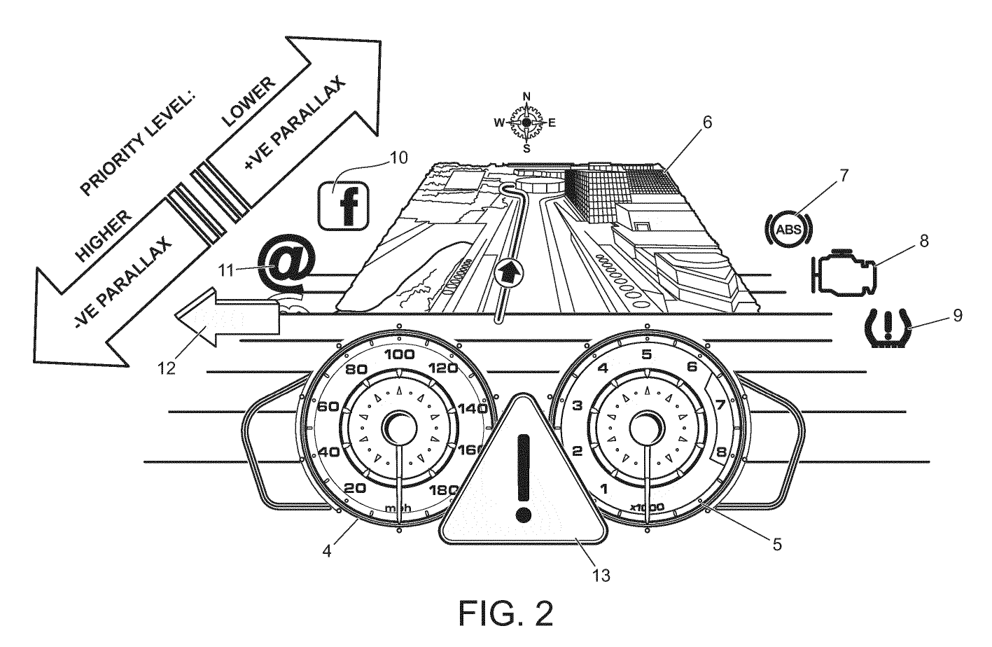

Consequently, as shown in FIG. 2, the panel 2 displays information at different priority levels and in different planes in the 3-D virtual space, the higher the priority the more negative the parallax, and the lower the priority the more positive the parallax. The 3-D virtual space is represented schematically in FIG. 2 by a series of horizontal lines corresponding to apparent planes within the image having different parallax values.

The display panel shows a speedometer 4, a rev counter 5 (both positioned at a relatively high priority level defined by the apparent plane in the parallax space second nearest to the user), a map 6 of the road ahead, and various infographics such as an ABS warning 7, an engine malfunction warning 8, and a tyre pressure warning 9 (all at relatively low priority levels), and other infographics such as a first icon 10 for accessing Facebook, a second icon 11 (the @ sign) for accessing the internet/emails, and a third icon 12 (an arrow) for warning that an indicator light is flashing. The highest priority infographic (indicated by an exclamation mark) 13 is positioned in the apparent plane nearest to the user, in front of and between the speedometer 4 and the rev counter 5, and provides a location for any urgent warning to the user. For example, if the ABS is faulty, the ABS icon 7 will be displayed as the highest priority infographic 13 without, however, obscuring either the speedometer 4 or the rev counter 5. The map 6 can be generated by a satnav unit, or from a database such as Google Maps.

The higher priority warnings are, therefore, located in the higher negative parallax distance with respect to the less urgent information, the higher the negative parallax that an infographic occupies, the closer it is perceived by a user, being positioned in a plane closer to the user. Similarly, the relative position of external objects with respect to the vehicle can be denoted by longitudinal position of indications in the image space.

The visual information that is fed to the user is sourced from the ECU 3, and it is channeled through to the 3-D autostereoscopic display panel 2. The 3-D autostereoscopic display system can sort out or prioritise the information received from the ECU 3, thus giving a level of ranking to how the information will be perceived by the user, and as such safety critical information will have the higher ranking than the infotainment information such as internet/emails and Facebook entries. The ECU 3 is programmed to prioritise safety critical information to be displayed at the highest priority infographic position 13.

The display panel 2 not only provides the user with additional depth information or infographics prioritisation, but enables the user to act on the information faster, or to enable the vehicle to communicate the information to the user more efficiently.

The main advantage of the system described above is that, by relaying the information in order of importance using parallax, the user can receive the important information faster and act upon it in a most efficient manner. Consequently, the time a user takes to respond to a safety critical warning is decreased.

If the motor vehicle 1 is fitted with cameras at the front and/or at the rear, the 3-D display technology could be used to represent the relative positions of external objects with respect to the vehicle. This information can be used by the driver to see out of line of sight objects around the vehicle. This enhances the level of information used by the 3-D display to give a perception of depth and distance with respect to the vehicle of nearby objects. The 3-D display system can, therefore, pre-build a virtual 3-D scene of all vehicles or objects around the driver's vehicle on the motorway for example, thus giving a driver a spatial relation of the vehicle position with respect to other vehicles; information that the driver can receive with a single glance on the 3-D display.

Using a 2-D display, the distance between vehicles can only be represented in a plan view. A 3-D image can, however, display the same information more intuitively by moving the relative position of the infographics within the 3-D virtual space. The 3-D image places a reduced cognitive load on the user.

As mentioned above, a conventional 2-D display has certain limitations regarding the display of icons and warning notifications. In particular, legislation requires that certain data remains available at all times - for example, icons cannot overlie the speedometer. The use of a 3-D display allows additional information to be displayed without obfuscating underlying information. For example, an icon can be displayed in the foreground of the image (at 13) to highlight its importance without relying exclusively on the size of the icon.

A 3-D display image offers faster perception and can reduce the response time required to perform an action, for example to respond to an engine warning notification. The invention relies on the increased depth perception of the 3-D image to highlight the urgency of messages. The information is displayed within the 3-D virtual space depending on its importance. The technical terminology for the virtual space is ‘parallax’ and is measured in dioptres.

The parallax depth of a given object in the display is related to its relative priority. By adjusting the parallax for different objects, it is possible to emphasise certain parts of the image and to de-emphasise other parts. One option is to display parts of the image in 3-D whilst the remainder of the image is displayed in a single plane in the parallax space. Alternatively, the non-critical infographics such as Facebook and internet/emails could permanently be positioned at a low priority level (high positive parallax plane).

The prominence of objects in the 3-D image could be fixed (for example, the location of the display objects in the virtual space can be specified by the manufacturer); or could be modified dynamically (for example, the user could reconfigure the location of display objects; or display objects could be moved within the virtual space to provide additional emphasis).

The invention has been developed using an autostereoscopic display, but other display types are envisaged, such as holographic displays or 3-D head-up displays. The display has an inherent maximum +/− parallax, and it is difficult to focus on display objects positioned beyond these limits.

It will be apparent, that the display system described above could be modified. For example, many other sorts of infographics (such as a reversing warning indicator) could be incorporated. In that case, the normal audible warning could be enhanced by a display at 13 of the actual distance of an object behind the reversing vehicle. It would also be possible for the apparent depths of the infographics to be pre-defined (for example the locations of the infographics in the virtual 3-D display space could be specified by the manufacturer) or modified dynamically (for example, the user could reconfigure the locations of the infographics, or infographics could be moved within the virtual 3-D space to provide additional emphasis).

A further modification would be to perform parallax scrolling of the infographics displayed in different apparent planes, for example based on the position of the user's head. A tracking system, such as an optical tracking apparatus, could be provided to track the position of the user's head.

Although the display system has been described above in connection with a motor vehicle, it will be apparent that it could be used with other forms of transport such as aircraft (civil or military) or other military vehicles, or with any other system that requires information to be presented to a user in as user-friendly manner as possible.

The specification of the Applicant's co-pending GB patent application (identified by our reference B-446) filed on the same date as this application relates to an instrument display system for a motor vehicle, the system having a 3-D instrument display panel, a programmable electronic control unit, and a camera at the front and/or the rear of the motor vehicle, the system being such that, in use, the display panel shows a 3-D image of the view at the front and/or the rear of the vehicle. The contents of the co-pending application are incorporated herein in their entirety by reference.

A further development of the system described herein would be to implement a spirit level and/or compass to facilitate off-road driving. A dynamic event countdown could be provided to provide a countdown based on navigation distance (for example a bar or gauge). A still further development would be to provide a traffic sign recognition warning, for example displayed in 3-D space to provide feedback on the position of the vehicle relative to the traffic sign (such as a turning or a speed sign).

Further aspects of the present invention are outlined in the followed series of numbered paragraphs:

1. An instrument display system comprising an instrument display panel and a programmable electronic control unit, wherein the instrument display panel is a 3-D instrument display panel configured to display infographics associated with parameters of a motor vehicle, and the electronic control unit is programmed to position each of the infographics at an apparent depth within the 3-D instrument display panel dependent on their priority.

2. A system as described in paragraph 1, wherein the electronic control unit is programmed to position the infographics associated with parameters of higher priority towards the apparent front of the 3-D instrument display panel.

3. A system as described in paragraph 1, wherein the 3-D instrument display panel defines a plurality of virtual display planes positioned at different apparent depths within the display panel.

4 A system as described in paragraph 3, wherein a first infographic comprises a speedometer of the motor vehicle, and the electronic control unit is programmed to position the first infographic in a first apparent display plane.

5. A system as described in paragraph 4, wherein the electronic control unit is programmed to position the first infographic in a first apparent display plane, and higher priority infographics are displayed in one or more apparent planes closer to the user.

6. A system as described in paragraph 4, wherein the electronic control unit is programmed so that the infographics of one or more critical parameters are normally displayed in apparent display planes having a greater apparent depth that the first apparent display plane, but each can be moved to apparent display planes having a smaller apparent depth than the first apparent display plane when the associated critical parameter is faulty or does not comply with a predetermined value or range of values.

7. A system as described in paragraph 6, wherein the critical parameter relates to one or more of the following: a tyre pressure warning, an ABS faulty warning, and an engine malfunction warning.

8. A system as described in paragraph 4, wherein the electronic control unit is programmed to position an infographic of highest priority in an apparent display plane in front of the first apparent display plane without obscuring the user's view of the speedometer infographic.

9. A system as described in paragraph 1, wherein the electronic control unit is programmed to choose an infographic of highest priority in dependence upon information received by the electronic control unit as to which of any one of a plurality of critical parameters is faulty or does not comply with a predetermined value or range of values.

10. A system as described in paragraph 1, wherein the 3-D display is an autostereoscopic parallax display which emits directionally-varying image information to present a 3-D image to the user, with higher priority infographics being displayed at negative parallax positions and lower priority infographics being displayed at positive parallax positions.

11. A motor vehicle incorporating an instrument display system as described in paragraph 1.

12. A motor vehicle as described in paragraph 11, further comprising a transmitter for sending warning information to the electronic control unit to identify which of a plurality of critical parameters is faulty or does not comply with a predetermined value or range of values.

13. A 3-D instrument display panel for a motor vehicle, wherein the 3-D display is an autostereoscopic parallax display which emits directionally-varying image information to present a 3-D image to the user, with higher priority infographics being displayed at negative parallax positions and lower priority infographics being displayed at positive parallax positions.

14. A method of displaying infographics associated with parameters of a motor vehicle, the method including the steps of sending information to an electronic control unit relating to parameters of the motor vehicle, programming the electronic unit to position infographics associated with the parameters on a 3-D instrument display panel so that infographics of higher priority are positioned so as to appear nearer to a user positioned in front of the panel.

15. A method as described in paragraph 14, further comprising the step of programming the electronic unit to position an infographic in the highest priority position apparently nearest the user in dependence upon information received by the electronic control unit as to which one of a plurality of critical parameters is faulty or does not comply with a predetermined value or range of values, said infographic being associated with said one critical parameter.

1. A system, comprising;
an instrument display panel; and
an electronic control unit,
wherein the instrument display panel is a 3-D instrument display panel configured to display infographics associated with parameters of a motor vehicle, and wherein the electronic control unit is programmed to position each of the infographics at an apparent depth within the 3-D instrument display panel dependent on their priority.

2. The system of claim 1, wherein the electronic control unit is programmed to position the infographics associated with parameters of higher priority towards an apparent front of the 3-D instrument display panel.

3. The system of claim 1, wherein the 3-D instrument display panel defines a plurality of virtual display planes positioned at different apparent depths within the display panel.

4. The system of claim 3, wherein a first infographic comprises a speedometer of the motor vehicle, and the electronic control unit is programmed to position the first infographic in a first apparent display plane.

5. The system of claim 4, wherein the electronic control unit is programmed to position the first infographic in a first apparent display plane, and higher priority infographics are displayed in one or more apparent planes closer to a user.

6. The system of claim 4, wherein the electronic control unit is programmed so that infographics of one or more critical parameters are normally displayed in apparent display planes having a greater apparent depth than the first apparent display plane, and wherein each of the infographics of the one or more critical parameters can be moved to apparent display planes having a smaller apparent depth than the first apparent display plane when the associated critical parameter is faulty or does not comply with a predetermined value or range of values.

7. The system of claim 6, wherein the one or more critical parameters relate to one or more of the following: a tyre pressure warning, an ABS faulty warning, and an engine malfunction warning.

8. The system of claim 4, wherein the electronic control unit is programmed to position an infographic of highest priority in an apparent display plane in front of the first apparent display plane without obscuring a user's view of the speedometer infographic.

9. The system of claim 1, wherein the electronic control unit is programmed to choose an infographic of highest priority in dependence upon information received by the electronic control unit as to which of any one of a plurality of critical parameters is faulty or does not comply with a predetermined value or range of values.

10. The system of claim 1, wherein the 3-D display is an autostereoscopic parallax display which emits directionally-varying image information to present a 3-D image to a user, with higher priority infographics being displayed at negative parallax positions and lower priority infographics being displayed at positive parallax positions.

11. A motor vehicle comprising the system of claim 1.

12. The motor vehicle of claim 11, further comprising a transmitter configured to send warning information to the electronic control unit to identify which of a plurality of critical parameters is faulty or does not comply with a predetermined value or range of values.

13. A 3-D instrument display panel for a motor vehicle, wherein the 3-D display is an autostereoscopic parallax display which emits directionally-varying image information to present a 3-D infographic to a user, the 3-D instrument display panel including a channel configured to receive a parallax position relating to the 3-D infographic from an electronic control unit, the 3-D display configured to present the 3-D infographic in dependence on the received parallax position, wherein the parallax position is indicative of the priority of the 3-D infographic, the parallax position being a negative parallax position if the 3-D infographic is of higher priority and the parallax position being a positive parallax position if the 3-D infographic is of lower priority.

14-17. (canceled)
